(19) United States
(12) Patent Application Publication
(10) Pub. No.: US 2005/0001708 A1
(43) Pub. Date: Jan. 6, 2005

(54) Dummy metal filling

(76) Inventors: Dawson W. Kesling, Davis, CA (US); Dong Wang, Sacramento, CA (US)

Correspondence Address: BUCKLEY, MASCHOFF, TALWALKAR LLC, 5 ELM STREET, NEW CANAAN, CT, 06840, US

(21) Appl. No.: 10/602,095

(22) Filed: Jun. 23, 2003

(51) Int. Cl. H01F 27/28

(52) U.S. Cl. 336/223

(57) ABSTRACT

Some embodiments provide an integrated inductor, and one or more electrically isolated metallic units disposed proximate to the inductor. The inductor and the one or more metallic units satisfy a metal density rule, and substantially no current is to flow within one or more of the one or more metallic units during operation of the inductor.

### BACKGROUND

Integrated circuits (ICs) usually consist of several individual layers. Due to submicron tolerances of conventional ICs, each layer must be flattened to a high degree before another layer is fabricated thereon. Chemical mechanical polishing (CMP) techniques are typically used to flatten IC layers. The success of CMP depends on the arrangement of dielectric material and metal within a layer. CMP may remove too much material if a layer includes too much metal, and may remove too little material if a layer includes too little metal.

Metal density rules are intended to improve the results of CMP by requiring each layer to include a particular amount of metal. This amount may be expressed in any form such as a percentage, a weight, or a volume, and may apply to any unit area of a circuit layer. For example, one metal density rule requires 0.13 μm copper-based ICs to include 20% to 80% copper metal in each 200 μm×200 μm area of a layer. Metal density rules may vary based on the type of metal considered and based on the layer to which they apply.

Integrated inductors often violate metal density rules due to the large non-metal areas that they circumscribe. FIG. 1 illustrates integrated inductor 10, which includes relatively large non-metal area 20. To satisfy some metal density rules, it may be possible to add metal to areas local to inductor 10. The addition of local metal may, however, reduce the Quality Factor (Q) of inductor 10.

### BRIEF DESCRIPTION OF THE DRAWINGS

FIG. 1 is an outward view of a conventional integrated inductor.

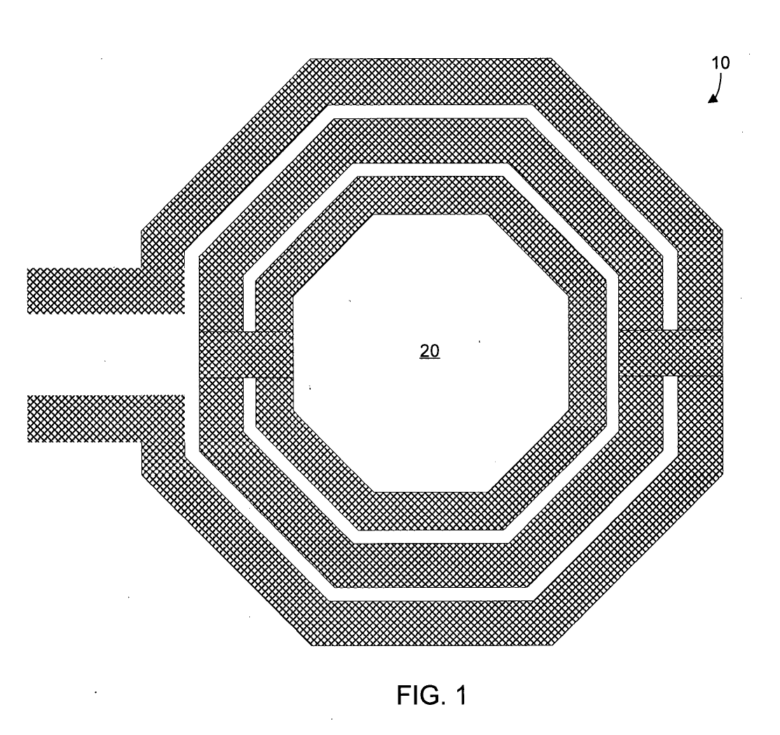

FIG. 2 is a representational view of integrated circuit layers according to some embodiments.

FIG. 3 is an outward view of a dummy metal filling pattern according to some embodiments.

FIG. 4 is a close-up view of the FIG. 3 dummy metal filling pattern according to some embodiments.

FIG. 5 is a block diagram of a system according to some embodiments.

### DETAILED DESCRIPTION

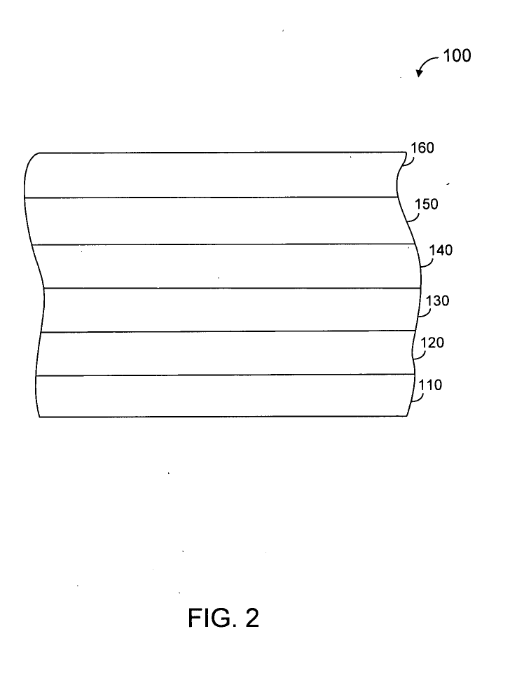

FIG. 2 is a representational view of layers of integrated circuit 100 according to some embodiments. Substrate 110 is a bottom-most layer of circuit 100. Substrate 110 may be composed of a semiconductor such as silicon in crystalline form. Device layer 120 overlays substrate 110 and may comprise a polysilicon layer that includes silicon-based devices such as transistors and diodes. Such devices may be fabricated using any currently- or hereafter-known systems.

One or more metal device layers may be fabricated on top of device layer 120. The metal device layers may include integrated devices such as inductors and capacitors, dielectric material, and interconnects for coupling the silicon-based devices and the integrated devices to one another. These interconnects may exist in a single layer and/or may comprise vias that connect devices across different layers. In this regard, a single integrated device may include elements that are disposed in more than one device layer.

An upper-most layer of IC 100 may consist of protective layer 160. Protective layer 160 may be composed of glass or a polymer, and is intended to protect the device layers of IC 100 from damage.

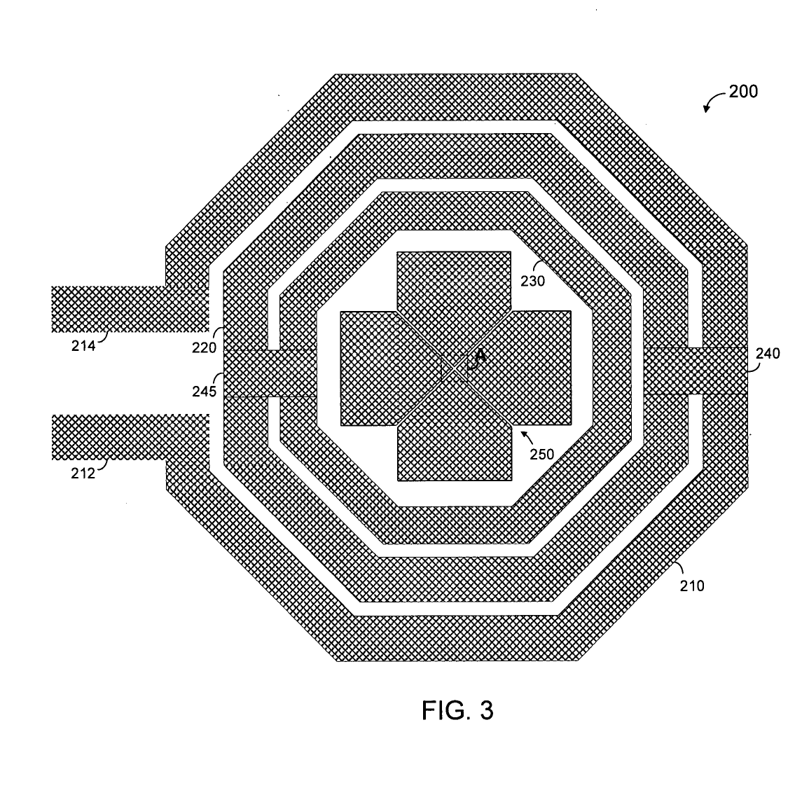

FIG. 3 is an outward view of inductor 200 according to some embodiments. Any type of device and/or device configuration may be used in accordance with some embodiments. For the present example, it will be assumed that inductor 200 is disposed within IC 100. Inductor 200 includes outer ring 210, middle ring 220, and inner ring 230. Outer ring 210 of includes terminals 212 and 214. Terminals 212 and 214 are used to connect inductor 200 to other devices of IC 100.

Connection 240 couples outer ring 210 to middle ring 220. Similarly, connection 245 couples middle ring 220 to inner ring 230. The above-described elements of inductor 200 may be disposed in one or more device layers of IC 100. For example, in some embodiments, outer ring 210 is disposed in layer 130, middle ring 220 is disposed in layer 140, and inner ring 230 is disposed in layer 150. Accordingly, connection 240 comprises a via between layer 130 and layer 140, and connection 245 comprises a via between layer 140 and layer 150.

In one example of operation, a signal flows from terminal 212 through a lower half of outer ring 210 and to middle ring 220 via connection 240. The signal continues through an upper half of middle ring 220 and to inner ring 230 via connection 245. The signal flows completely through inner ring 230 and out to middle ring 220 via connection 245. After passing through a lower half of middle ring 220, the signal exits to a top half of outer ring 210 and on to terminal 214 via connection 240.

Metallic units 250 are disposed proximate to inductor 200 within an area circumscribed by inner ring 230. Metallic units 250 may be sized and/or shaped to satisfy a metal density rule in conjunction with inductor 200. In a case that elements of inductor 200 are disposed in respective ones of a plurality of device layers, one or more of metallic units 250 may be disposed proximate to the inductor elements in the plurality of device layers. In some embodiments, such a configuration satisfies a metal density rule for each of the plurality of device layers.

Metallic units 250 and inductor 200 may be composed of an identical metal. Suitable metals include copper and aluminum. Metallic units 250 may also be sized and/or shaped such that substantially no current is to flow within one or more of metallic units 250 during operation of inductor 200. In this regard, alternating magnetic fields produced within an AC-energized inductor tend to induce circulating currents within proximate metal structures. These circulating currents may increase a resistance between terminals of the inductor, thereby decreasing the Q of the inductor. Metallic units 250 according to some embodiments may therefore provide compliance with an applicable metal density rule while not substantially decreasing a Q of inductor 200.

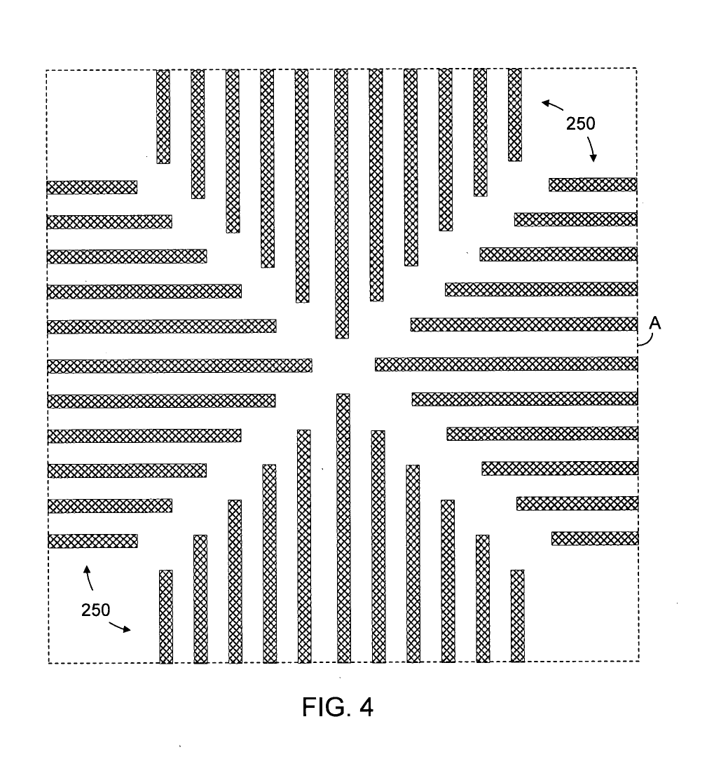

FIG. 4 is a close-up view of metallic units 250 according to some embodiments. More particularly, FIG. 4 shows the area delineated by box A of FIG. 3. As shown, metallic units 250 may comprise one or more electrically-isolated metallic units. The one or more electrically-isolated metallic units may be referred to as dummy metal. In general, dummy metal consists of metallic units that are not elements of nor electrically connected to any device of IC 100.

A width of one or more of metallic units 250 may be substantially smaller than a width of one or more elements of inductor 200. As described above, metallic units 250 may be sized and/or shaped such that substantially no current is to flow within one or more of metallic units 250 during operation of inductor 200. Any shape, size and/or configuration of metallic units 250 may be used in conjunction with some embodiments.

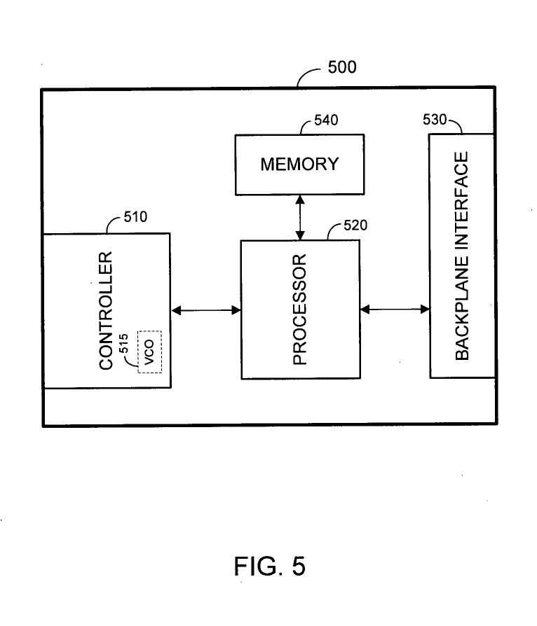

FIG. 5 is a block diagram of line card 500 according to some embodiments. Line card 500 may provide an interface between a main backplane and an Ethernet network. Line card 500 may comprise a circuit board onto which the illustrated elements are mounted. The elements include controller 510, processor 520, backplane interface 530, and memory 540.

Controller 510 may be an Ethernet controller providing MAC and PHY layer functions for Ethernet communication. A transmitting section of controller 510 may comprise voltage-controlled oscillator 515 including inductor 200 and metallic units 250 according to some embodiments. Inductor 200 and metallic units 250 may comprise elements of an LC tank on which an oscillation frequency of voltage-controlled oscillator 515 is based.

Processor 520 receives/transmits data from/to controller 510 and backplane interface 530. Backplane interface 530, in turn, communicates with a backplane such as a network server or a network switch backplane. Memory 540 is coupled to processor 520 and may therefore receive data from controller 510 via processor 520. Memory 540 may comprise a Double Data Rate Random Access Memory, a Single Data Rate Random Access Memory, or any other suitable memory. Memory 540 may store code executable by processor 520 and/or other data for use by processor 520.

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

1. A device comprising:
an integrated inductor; and
one or more electrically isolated metallic units disposed proximate to the inductor, the inductor and the one or more units to satisfy a metal density rule,
wherein substantially no current is to flow within one or more of the one or more metallic units during operation of the inductor.

2. A device according to claim 1, wherein the inductor comprises a metal, and wherein one or more of the one or more metallic units comprises the metal.

3. A device according to claim 2, wherein the metal is copper.

4. A device according to claim 2, wherein the metal is aluminum.

5. A device according to claim 1, wherein the inductor comprises a plurality of inductor elements disposed in respective ones of a plurality of device layers, and wherein the one or more metallic units are disposed proximate to the inductor elements in the plurality of device layers, the inductor elements and the one or more metallic units in a device layer to satisfy the metal density rule for the device layer.

6. A device according to claim 1, wherein the inductor comprises a plurality of inductor elements, and wherein a width of one or more of the one or more metallic units is substantially smaller than a width of one or more of the plurality of inductor elements.

7. A device according to claim 1, wherein the one or more metallic strips do not substantially decrease a Q of the inductor during operation of the inductor.

8. A method comprising:
fabricating an integrated inductor; and
fabricating one or more electrically isolated metallic units proximate to the inductor, the inductor and the one or more units to satisfy a metal density rule,
wherein substantially no current is to flow within one or more of the one or more metallic units during operation of the inductor.

9. A method according to claim 8, wherein the inductor comprises a metal, and wherein one or more of the one or more metallic units comprises the metal.

10. A method according to claim 9, wherein the metal is copper.

11. A method according to claim 9, wherein the metal is aluminum.

12. A method according to claim 8, wherein fabricating the inductor comprises:
fabricating a plurality of inductor elements in respective ones of a plurality of device layers, and
wherein fabricating the one or more metallic units comprises:
fabricating the one or more metallic units proximate to the inductor elements in the plurality of device layers,
the inductor elements and the one or more metallic units in a device layer to satisfy the metal density rule for the device layer.

13. A method according to claim 8, wherein fabricating the inductor comprises:
fabricating a plurality of inductor elements, and
wherein fabricating the one or more metallic units comprises:
fabricating one or more of the one or more metallic units having a width substantially smaller than a width of one or more of the plurality of inductor elements.

14. A method according to claim 8, wherein the one or more metallic strips do not substantially decrease a Q of the inductor during operation of the inductor.

15. A system comprising:
a controller comprising a voltage-controlled oscillator, the voltage-controlled oscillator comprising:
an integrated inductor; and
one or more electrically isolated metallic units disposed proximate to the inductor, the inductor and the one or more units to satisfy a metal density rule,
wherein substantially no current is to flow within one or more of the one or more metallic units during operation of the inductor; and
a double data rate memory in communication with the controller.

16. A system according to claim 15, further comprising:
a processor coupled to the controller and to the memory, the processor to receive data from the controller and to transmit the data to the memory.
